(19) United States
(12) Patent Application Publication
(10) Pub. No.: US 2024/0349396 A1
(43) Pub. Date: Oct. 17, 2024

(54) METHOD AND APPARATUS FOR DRX-BASED SIDELINK COMMUNICATION

(71) Applicants: HYUNDAI MOTOR COMPANY, Seoul (KR); KIA CORPORATION, Seoul (KR)

(72) Inventors: Ui Hyun Hong, Hwaseong-si (KR); Gene Back Hahn, Hwaseong-si (KR); Hyuk Min Son, Seoul (KR)

(73) Assignees: HYUNDAI MOTOR COMPANY, Seoul (KR); KIA CORPORATION, Seoul (KR); WONKWANG UNIVERSITY CENTER FOR INDUSTRY-ACADEMY COOPERATION, Iksan-si (KR)

(21) Appl. No.: 18/752,154

(22) Filed: Jun. 24, 2024

Related U.S. Application Data
(63) Continuation of application No. PCT/KR2022/021654, filed on Dec. 29, 2022.

(30) Foreign Application Priority Data
Jan. 10, 2022 (KR) 10-2022-0003581

(51) Int. Cl. H04W 76/28; H04L 1/1829; H04W 72/25

(52) U.S. Cl. CPC H04W 76/28; H04L 1/1864; H04W 72/25

(57) ABSTRACT

Disclosed are a method and apparatus for DRX-based sidelink communication. The method for first UE comprises the steps of: generating a DRX control signal for controlling a DRX operation; and transmitting the DRX control signal to second UE at an active time of the second UE according to the DRX operation.

### TECHNICAL FIELD

The present disclosure relates to a sidelink communication technique, and more particularly, to a technique for transmitting and receiving data in sidelink communication based on discontinuous reception (DRX).

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, a transmitting terminal may perform a resource sensing operation, perform a resource selection operation for sensed resources, and perform sidelink communication using selected resources. In sidelink communication, a discontinuous reception (DRX) operation may be supported. In the instant case, the receiving terminal may operate according to a DRX cycle, and the transmitting terminal may perform the resource sensing operation and/or resource selection operation considering the DRX cycle. For example, the transmitting terminal may perform the resource sensing operation and/or resource selection operation in a DRX active time of the receiving terminal. There may not be sufficient resources available for sidelink communication within the DRX active time. In the instant case, the transmitting terminal may be unable to perform sidelink communication with the receiving terminal. Methods to address these issues are required.

### DISCLOSURE

### Technical Problem

The present disclosure is directed to providing a method and an apparatus for transmitting and receiving data in sidelink communication based on DRX.

### Technical Solution

A method of a first user equipment (UE), according to a first exemplary embodiment of the present disclosure for achieving the above-described objective, may comprise: generating a discontinuous reception (DRX) control signal for controlling a DRX operation; and transmitting the DRX control signal to a second UE in an active time of the second UE according to the DRX operation.

The DRX control signal may include at least one of information indicating to stop the DRX operation, information indicating to transition an operating state of the second UE, information indicating to change a DRX cycle according to the DRX operation, or information indicating to extend the active time.

When the DRX control signal indicates to stop the DRX operation, the DRX operation may not be performed in the second UE, and when the DRX control signal indicates to transition the operating state, the operating state of the second UE may transition to a wake-up state.

When the DRX control signal indicates to change the DRX cycle, the DRX cycle of the second UE may be changed from a first DRX cycle to a second DRX cycle, and a length of the first DRX cycle and a length of the second DRX cycle may be different from each other.

The method may further comprise: in response that the DRX control signal indicating to extend the active time, performing sidelink (SL) communication with the second UE in an extended active time of the second UE.

The performing of the SL communication may comprise: transmitting data to the second UE; and receiving, from the second UE, a hybrid automatic repeat request (HARQ) feedback for the data.

The performing of the SL communication may comprise: receiving, from the second UE, a HARQ response to the DRX control signal; and transmitting data to the second UE.

The performing of the SL communication may comprise: performing a resource sensing operation in a first resource sensing window within the extended active time; performing a resource selection operation for sensed resources in a first resource selection window within the extended active time; and transmitting data to the second UE using selected resources, wherein the first resource sensing window may be larger than a second resource sensing window within the active time, and the first resource selection window may be larger than a second resource selection window within the active time.

The extended active time may include the active time and an additional on-duration, and the additional-on duration may be configured by the base station.

The DRX control signal may be transmitted in the active time of a DRX cycle #n, and the extended active time may be configured in a DRX cycle #n+k, and n and k may each be natural numbers.

A method of a second UE, according to a second exemplary embodiment of the present disclosure for achieving the above-described objective, may comprise: performing a monitoring operation in an active time according to a discontinuous reception (DRX) operation; receiving a DRX control signal for controlling the DRX operation from a first UE by the monitoring operation; and performing sidelink (SL) communication with the first UE based on the DRX control signal.

The DRX control signal may include at least one of information indicating to stop the DRX operation, information indicating to transition an operating state of the second UE, information indicating to change a DRX cycle according to the DRX operation, or information indicating to extend the active time.

When the DRX control signal indicates to stop the DRX operation, the SL communication may be performed without the DRX operation, and when the DRX control signal indicates to transition the operating state, the operating state of the second UE may transition to a wake-up state.

When the DRX control signal indicates to change the DRX cycle, the DRX cycle of the second UE may be changed from a first DRX cycle to a second DRX cycle, and a length of the first DRX cycle and a length of the second DRX cycle may be different from each other.

When the DRX control signal indicates to extend the active time, the SL communication may be performed in an extended active time of the second UE.

The performing of the SL communication may comprise: receiving data from the first UE; and transmitting a hybrid automatic repeat request (HARQ) feedback for the data to the first UE.

The performing of the SL communication may comprise: transmitting a HARQ response to the DRX control signal to the first UE; and receiving data from the first UE.

The extended active time may include the active time and an additional on-duration, and the additional-on duration may be configured by the base station.

The DRX control signal may be received in the active time of a DRX cycle #n, and the extended active time may be configured in a DRX cycle #n+k, and n and k may each be natural numbers.

### Advantageous Effects

According to the present disclosure, the transmitting terminal can transmit a DRX control signal to the receiving terminal, which includes information requesting to extend an active of the receiving terminal, and perform SL communication with the receiving terminal by conducting a resource sensing operation and/or resource selection operation in the extended active time. Since the resource sensing operation and/or resource selection operation is conducted in the extended active time, sufficient resources can be sensed (or selected) for data transmission. Consequently, the sidelink communication can be efficiently performed.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a sequence chart illustrating a first exemplary embodiment of DRX-based sidelink communication.

FIG. 10 is a sequence chart illustrating a second exemplary embodiment of DRX-based sidelink communication.

FIG. 11 is a sequence chart illustrating a third exemplary embodiment of DRX-based sidelink communication.

FIG. 12 is a sequence chart illustrating a fourth exemplary embodiment of DRX-based sidelink communication.

FIG. 13 is a sequence chart illustrating a fifth exemplary embodiment of DRX-based sidelink communication.

FIG. 14 is a sequence chart illustrating a sixth exemplary embodiment of DRX-based sidelink communication.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

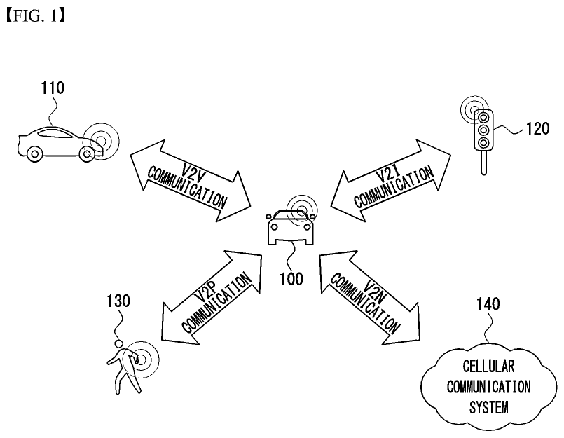

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications’. Here, the communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink communication technologies (e.g., Proximity Based Services (ProSe) and Device-to-Device (D2D) communication technologies, and the like). In the instant case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In the instant case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In the instant case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3GPP standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

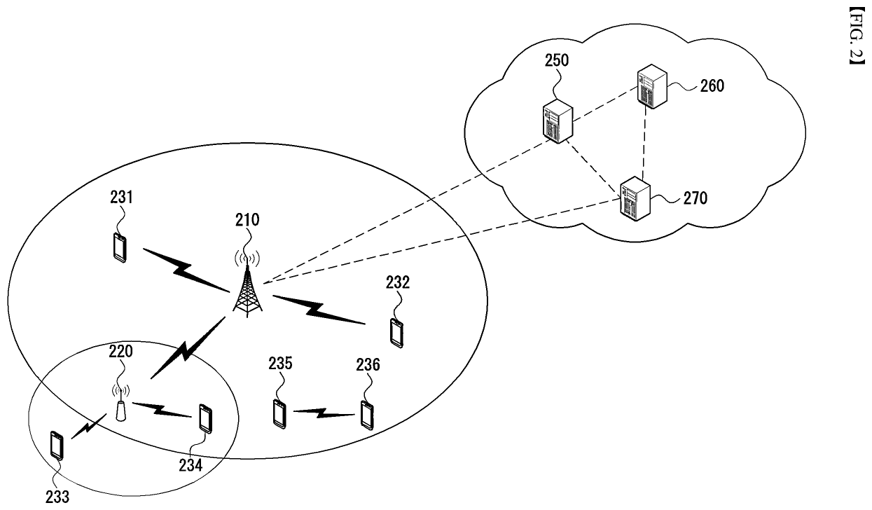

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slices configured in the core network.

The communication nodes (e.g., base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) constituting the communication system may be configured as follows.

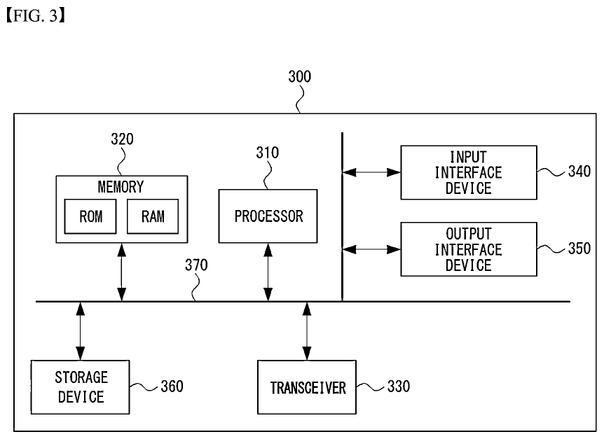

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, etc.), coordinated multipoint (COMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

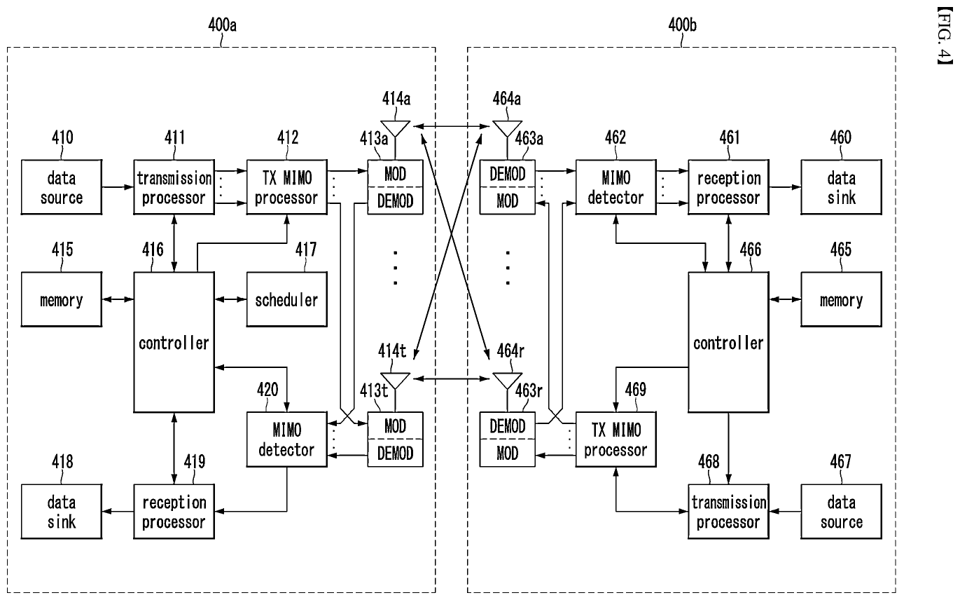

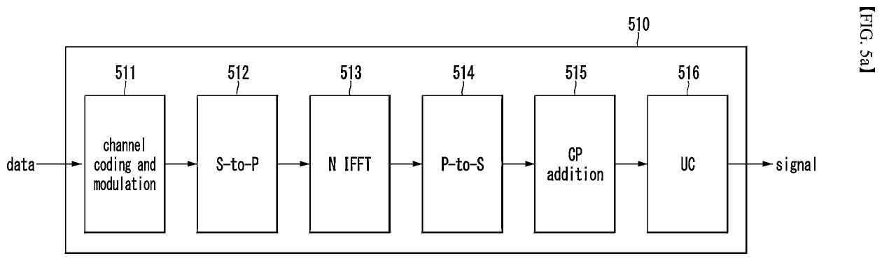

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of | Out of coverage of |
| | base station 210 | base station 210 |
| B | In coverage of | Out of coverage of |
| | base station 210 | base station 210 |
| C | In coverage of | In coverage of |
| | base station 210 | base station 210 |
| D | In coverage of | In coverage of |
| | base station 210 | other base station |

Meanwhile, a user plane protocol stack of the UEs (e.g., the UEs 235 and 236) performing sidelink communications may be configured as follows.

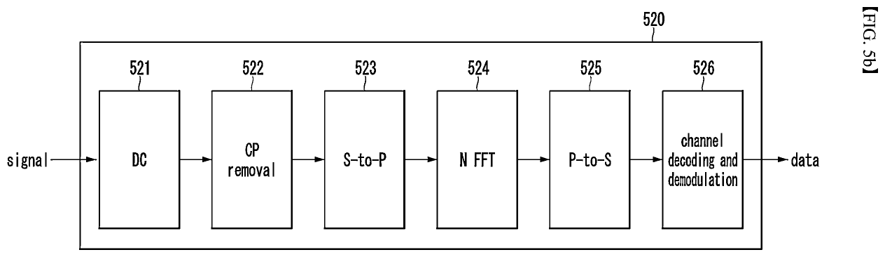

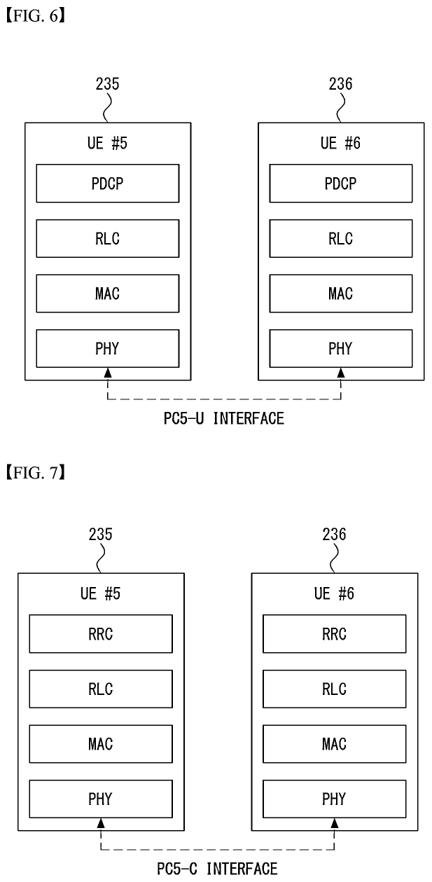

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

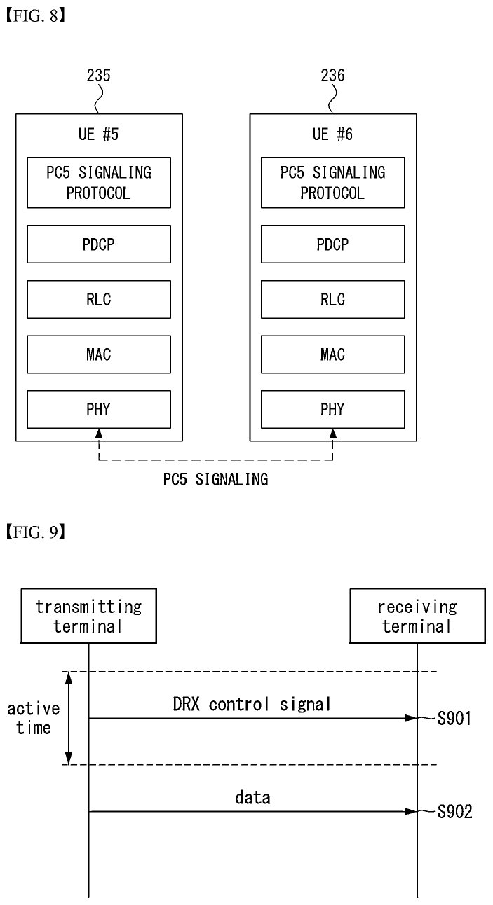

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink TM | Description |
|---|---|
| 1 | Transmission using resources |
| | scheduled by base station |
| 2 | UE autonomous transmission without |
| | scheduling of base station |
| 3 | Transmission using resources scheduled by |
| | base station in V2X communications |
| 4 | UE autonomous transmission without scheduling |
| | of base station in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In the instant case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In the instant case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In the instant case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In the instant case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e. sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-InterUE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In the instant case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In the instant case, the SCI format 2-C may include at least one among a priority, number of subchannels, resource reservation period, resource selection window location, resource set type, or padding bit(s).

Meanwhile, in sidelink communication, terminals may be classified into a transmitting terminal (TX-UE) and a receiving terminal (RX-UE). The transmitting terminal may refer to a terminal that transmits data (e.g., SL data, data unit). The receiving terminal may refer to a terminal that receives data (e.g., SL data, data unit). The transmitting terminal may be referred to as a first terminal, and In the instant case, the receiving terminal may be referred to as a second terminal. Alternatively, the receiving terminal may be referred to as a first terminal, and In the instant case, the transmitting terminal may be referred to as a second terminal. A discontinuous reception (DRX) operation may be supported in sidelink communication. In the instant case, the receiving terminal may operate according to a DRX cycle. An on-duration within a DRX cycle may be referred to as active time, DRX active time, SL active time, or SL DRX active time. A duration (e.g., off-duration) other than the on-duration within the DRX cycle may be referred to as inactive time, DRX inactive time, SL inactive time, or SL DRX inactive time.

In an on-duration (e.g., DRX active time), the transmitting terminal may transmit a sidelink channel and/or signal, and the receiving terminal may receive the sidelink channel and/or signal. The sidelink channel and/or signal transmitted and received in the on-duration may include a signal for controlling the DRX operation (e.g., paging signal). In an off-duration (e.g., DRX inactive time), the transmitting terminal may not transmit a sidelink channel and/or signal, and the receiving terminal may not perform a reception operation (e.g., monitoring operation) of a sidelink channel and/or signal. A terminal operating in the RRC idle state, RRC inactive state, or RRC connected state may perform the DRX operation (e.g., SL DRX operation).

The transmitting terminal may perform a resource sensing/selection operation by considering a DRX cycle of the receiving terminal. In the present disclosure, the resource sensing/selection operation may refer to at least one of a resource sensing operation or a resource selection operation. That is, performing a resource sensing/selection operation may refer to ‘performing a resource sensing operation’, ‘performing a resource selection operation’, or ‘performing a resource sensing operation and a resource selection operation’. In addition, a resource sensing operation may be used as a term to mean an operation including resource sensing and resource selection. Alternatively, a resource selection operation may be used as a term to mean an operation including resource sensing and resource selection.

For example, the transmitting terminal may perform a resource sensing/selection operation in a DRX active time. Resources for sidelink communication within the DRX active time may not be sufficient. When a value of drx-onDurationTimer is set to a small value (e.g., when the DRX active time is short), sufficient resources for sidelink communication may not be sensed (or selected) within the DRX active time. In the instant case, the transmitting terminal may not be able to transmit data to the receiving terminal. Methods are needed to solve these problems.

FIG. 9 is a sequence chart illustrating a first exemplary embodiment of DRX-based sidelink communication.

As shown in FIG. 9, a DRX operation may be supported in sidelink communication, and a receiving terminal may operate according to a DRX cycle. When data to be transmitted to the receiving terminal exists in a transmitting terminal, the transmitting terminal may transmit a DRX control signal to the receiving terminal within an active time (S901). The receiving terminal may perform a reception operation (e.g., monitoring operation) for a sidelink channel and/or signal in the active time. Therefore, the receiving terminal may receive the DRX control signal of the transmitting terminal in the active time. The DRX control signal may refer to a signal for controlling the DRX operation. The DRX control signal may be a paging signal (e.g., paging message).

The DRX control signal may be transmitted on a PSCCH and/or PSSCH. The DRX control signal may be included in SCI (e.g., first-stage SCI and/or second-stage SCI). The DRX control signal may include resource information (e.g., scheduling information) for transmission of data (e.g., SL data). Alternatively, the DRX control signal may not include resource information for transmission of data.

When the DRX control signal includes resource information for transmission of data and is transmitted on a PSCCH and PSSCH, the resource information for transmission of the data may be included in at least one of first-stage SCI, second-stage SCI, data (e.g., data excluding second-stage SCI from a PSSCH), or MAC CE. When the DRX control signal includes resource information for transmission of data and is transmitted on a PSCCH, the resource information for transmission of the data may be included in at least one of first-stage SCI or MAC CE.

The resource information may indicate some or all of resources sensed (or, resources selected) by the transmitting terminal within the active time of the receiving terminal. Alternatively, the resource information may indicate some or all of the resources sensed (or selected resources) by the transmitting terminal within an inactive time of the receiving terminal. A physical (PHY) layer of the transmitting terminal may deliver the resource information to a MAC layer of the transmitting terminal.

After receiving the DRX control signal of the transmitting terminal, the receiving terminal may perform a reception operation for the data. The reception operation when the DRX control signal includes the resource information may be distinguished from a reception operation when the DRX control signal does not include the resource information. For example, the transmitting terminal may schedule, allocate, or reserve resources for data transmission and reception by transmitting the DRX control signal. In order to perform the reception operation for the data in scheduled resources, the receiving terminal may stop the DRX operation, extend the active time, change the DRX cycle, and/or transition to a wake-up state. For the resource sensing/selection operation of the transmitting terminal for data transmission, the DRX control signal may include information indicating to stop the DRX operation and/or information indicating to extend the active time.

### Case When a DRX Control Signal Includes Resource Information for Data Transmission

When the DRX control signal includes the resource information for data transmission, the receiving terminal may stop the DRX operation after receiving the DRX control signal. After stopping the DRX operation, normal SL data transmission and reception operations may be performed. For example, the transmitting terminal may transmit data to the receiving terminal (S902). When necessary, the transmitting terminal may perform a resource sensing/selection operation and then transmit data to the receiving terminal. The receiving terminal may receive the data from the transmitting terminal.

Alternatively, even when the DRX control signal is received, the receiving terminal may not stop the DRX operation. In the instant case, even when a period indicated by the resource information included in the DRX control signal belongs to an inactive period of the receiving terminal, the operating state of the receiving terminal may transition to the wake-up state, and the receiving terminal operating in the wake-up state may perform a reception operation for data in the period indicated by the DRX control signal.

A period from a reception time of the DRX control signal to a reception time of the data may belong to an inactive time of the receiving terminal. Even In the instant case, the receiving terminal may operate in the wake-up state after receiving the DRX control signal and perform a reception operation for the data. Alternatively, the receiving terminal may not stop the DRX operation after receiving the DRX control signal. In the instant case, the active time of the receiving terminal may be extended, and data transmission and reception operations may be performed in the extended active time.

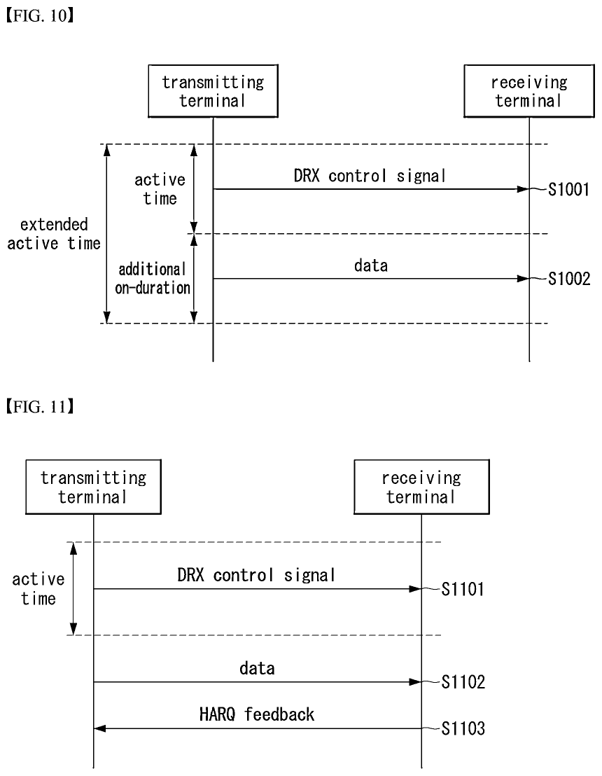

FIG. 10 is a sequence chart illustrating a second exemplary embodiment of DRX-based sidelink communication.

As shown in FIG. 10, a DRX operation may be supported in sidelink communication, and a receiving terminal may operate according to a DRX cycle. When data to be transmitted to the receiving terminal exists in a transmitting terminal, the transmitting terminal may transmit a DRX control signal to the receiving terminal within an active time (S1001). The receiving terminal may perform a reception operation (e.g., monitoring operation) for a sidelink channel and/or signal in the active time. Therefore, the receiving terminal may receive the DRX control signal of the transmitting terminal in the active time.

After receiving the DRX control signal of the transmitting terminal, the receiving terminal may extend the active time by a preset time (e.g., additional on-duration) after the active time according to the DRX cycle ends. The DRX control signal may include information indicating to extend the active time or information indicating to enable the additional on-duration. The receiving terminal may operate in the wake-up state in the extended active time. After transmitting the DRX control signal, the transmitting terminal may expect (or estimate, assume) that the active time of the receiving terminal is extended by the preset time (e.g., additional on-duration). The transmitting terminal may transmit data to the receiving terminal in the extended active time (e.g., active time+additional on-duration) of the receiving terminal (S1002). The receiving terminal may perform a reception operation for the data in the extended active time.

When resources sensed (e.g., resources selected) by a resource sensing/selection operation within the active time of the receiving terminal are not sufficient for data transmission, the transmitting terminal may transmit the DRX control signal. For example, when the size of the resources sensed (e.g., resources selected) by the resource sensing/selection operation within the active time is less than or equal to a threshold, the transmitting terminal may transmit the DRX control signal to extend the active time. The base station may configure the above-described threshold to the terminal(s) using at least one of system information, RRC message, MAC message, or PHY message.

The additional on-duration and/or extended active time may be configured by the base station or terminal. For example, the base station may transmit information on the additional on-duration and/or extended active time to the terminal(s) by using at least one of system information, RRC message, MAC message (e.g., MAC CE), or PHY message (e.g., DCI). Alternatively, a first terminal (e.g., transmitting terminal) may transmit information on the additional on-duration and/or extended active time to a second terminal (e.g., receiving terminal) by using at least one of system information, RRC message, MAC message (e.g., MAC CE), or PHY message (e.g., SCI). The DRX control signal may include information on the additional on-duration and/or extended active time. drx-inactivity-Timer may be used to indicate the additional on-duration and/or extended active time.

The additional on-duration (e.g., extended active time) may be applied from an end time of the active time. Alternatively, the additional on-duration may be applied from a reception time of the DRX control signal. Alternatively, the additional on-duration (e.g., extended active time) may be applied in the next DRX cycle. For example, when the DRX control signal is received in a DRX cycle #n of the receiving terminal, the receiving terminal may apply the additional on-duration (e.g., extended active time) from a DRX cycle #n+k after the DRX cycle #n, and the transmitting terminal may expect (or estimate, consider) that the additional on-duration (e.g., extended active time) is applied from the DRX cycle #n+k after the DRX cycle #n. Each of n and k may be a natural number. The base station may configure a value of k to the terminal(s) using at least one of system information, RRC message, MAC message, or PHY message.

The transmitting terminal may perform a resource sensing/selection operation in the extended active time and may perform SL communication with the receiving terminal using sensed resources (e.g., selected resources). A resource sensing window in the extended active time may be larger than a resource sensing window in the existing active time (i.e. non-extended active time). A resource selection window in the extended active time may be larger than a resource selection window in the existing active time (i.e. non-extended active time). That is, after transmitting the DRX control signal, the transmitting terminal may perform a resource sensing operation in the extended resource sensing window within the extended active time and perform a resource selection operation for sensed resources in the extended resource selection window. The base station may transmit information on the extended resource sensing window and/or extended resource selection window to the terminal(s) using at least one of system information, RRC message, MAC message, or PHY message.

In the present disclosure, a reception time may mean a reception start time or a reception end time, and a transmission time may mean a transmission start time or a transmission end time. The active time, extended active time, and/or additional on-duration may be configured in units of slots. The reception time of the DRX control signal may be configured in units of slots.

After the transmission and reception operations of data (e.g., SL data) are completed, the receiving terminal may perform the DRX operation based on the DRX configuration information. Alternatively, the transmitting terminal may control the DRX operation of the receiving terminal by transmitting a DRX operation indicator in the transmission and reception operations of data. The DRX operation indicator may indicate whether to perform the DRX operation. For example, the DRX operation indicator set to a first value may indicate to perform the DRX operation, and the DRX operation indicator set to a second value may indicate to stop the DRX operation. The DRX operation indicator may be included in at least one of first-stage SCI, second-stage SCI, data (e.g., data excluding second-stage SCI from a PSCCH), or MAC CE. The DRX operation indicator may be included in the DRX control signal described above.

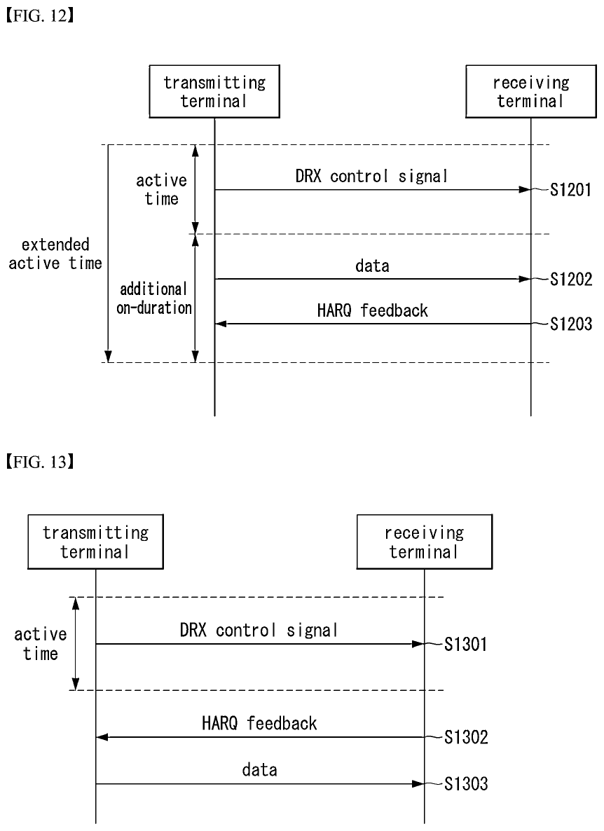

FIG. 11 is a sequence chart illustrating a third exemplary embodiment of DRX-based sidelink communication, and FIG. 12 is a sequence chart illustrating a fourth exemplary embodiment of DRX-based sidelink communication.

As shown in FIGS. 11 and 12, a DRX operation may be supported in sidelink communication, and a receiving terminal may operate according to a DRX cycle. When data to be transmitted to the receiving terminal exists in a transmitting terminal, the transmitting terminal may transmit a DRX control signal to the receiving terminal within an active time (S1101, S1201). The receiving terminal may perform a reception operation (e.g., monitoring operation) for a sidelink channel and/or signal in the active time. Therefore, the receiving terminal may receive the DRX control signal of the transmitting terminal in the active time.

The transmitting terminal may transmit data to the receiving terminal (S1102, S1202). The receiving terminal may perform a reception operation for the data. The receiving terminal may transmit a HARQ feedback for the data to the transmitting terminal (S1103, S1203). The transmitting terminal may receive the HARQ feedback for the data from the receiving terminal. In the exemplary embodiment of FIG. 11, the data and HARQ feedback may be transmitted and received in an inactive time of the receiving terminal. In the exemplary embodiment of FIG. 12, the data and HARQ feedback may be transmitted and received in an extended active time (e.g., additional on-duration) of the receiving terminal. The HARQ feedback may refer to a HARQ response, HARQ-ACK, or HARQ-ACK information.

Whether DRX control information is received at the receiving terminal may be identified based on the HARQ feedback. The DRX control information may be included in the DRX control signal. Alternatively, the DRX control information may be transmitted after transmission of the DRX control signal. In the instant case, the DRX control information may be included in data (e.g., SL data) transmitted from the transmitting terminal to the receiving terminal. The DRX control information may be control information to stop the DRX operation, extend the active time, change the DRX cycle, and/or transition the operating state (e.g., wake-up state).

The DRX control information may be included in the DRX control signal or may not be included in the data. In the instant case, the transmitting terminal may receive the HARQ feedback for the data from the receiving terminal and may identify whether the data has been received based on the HARQ feedback. The DRX operation of the receiving terminal may be stopped based on information (or indicated information) configured by the DRX control signal.

The HARQ feedback may be transmitted and received on a PSFCH. Resource information for the PSFCH may be included in at least one of first-stage SCI, second-stage SCI, data (e.g., data excluding second-stage SCI from a PSCCH), or MAC CE. A plurality of PSFCH resources may exist within a resource pool. The receiving terminal may select specific PSFCH resource(s) from the plurality of PSFCH resources in consideration of an identifier (ID) of the transmitting terminal, ID of the receiving terminal, and/or parameter according to a cast scheme, and transmit the HARQ feedback in the selected specific PSFCH resource(s). The cast scheme may be classified into a broadcast scheme, groupcast scheme, or unicast scheme. The receiving terminal may select the earliest PSFCH resource in the time domain among the plurality of PSFCH resources within the resource pool, and may transmit the HARQ feedback to the transmitting terminal using the selected PSFCH resource.

In the exemplary embodiment of FIG. 11, the PSFCH resource may be located within an inactive time. In the instant case, the receiving terminal may operate in the wake-up state in a period from a reception time of the DRX control signal to the PSFCH resource. Alternatively, the receiving terminal may operate in the wake-up state in the PSFCH resource. Therefore, the receiving terminal may transmit the HARQ feedback in the PSFCH resource. In the exemplary embodiment of FIG. 12, transmission and reception operations of the data and HARQ feedback may be performed within an extended active time (e.g., additional on-duration) of the receiving terminal.

In the exemplary embodiments of FIGS. 11 and 12, whether to perform the DRX operation may be determined depending on whether the HARQ feedback for data is transmitted and received. If the transmitting terminal does not receive the HARQ feedback in the PSFCH resource, the transmitting terminal may re-perform the resource sensing/selection operation in an active time of the receiving terminal, and retransmit the DRX control signal and/or data by using sensed resources (e.g., selected resources). When the data can be transmitted in the sensed resources (e.g., selected resources) within the active time of the receiving terminal, the transmitting terminal may retransmit the data. When the resources sensed (e.g., selected resources) in the active time of the receiving terminal are not sufficient for transmission of the data, the transmitting terminal may retransmit the DRX control signal instead of the data.

The DRX control signal may include information indicating that the signal is a DRX control signal. The information (e.g., indication information of the DRX control signal) may be included in at least one of first-stage SCI, second-stage SCI, data (e.g., data excluding second-stage SCI from a PSCCH), or MAC CE.

When the HARQ feedback (e.g., acknowledgment (ACK) or negative ACK (NACK)) is transmitted and received, the DRX operation may be stopped. Data transmission and reception operations may be performed without the DRX operation. When the HARQ feedback indicates ACK, the transmitting terminal may transmit new data to the receiving terminal. When the HARQ feedback indicates NACK, the transmitting terminal may retransmit the data to the receiving terminal. When HARQ feedback is not transmitted and received, the DRX operation may continue to be performed. When the HARQ feedback is transmitted and received, the DRX operation may be stopped, and the transmitting terminal may transmit data to the receiving terminal without considering the DRX cycle of the receiving terminal.

The exemplary embodiments of FIGS. 9 to 12 may be extended and/or modified based on extension of the active time and/or control on the DRX cycle. When the active time is extended, the DRX cycle may be changed from a long DRX cycle to a short DRX cycle for smooth transmission and reception of data. Indication or configuration information for changing (or controlling) the DRX cycle may be included in the DRX control signal.

### Case When a DRX Control Signal Does Not Include Resource Information for Data Transmission

The DRX control signal may not include resource information for data transmission. In the exemplary embodiments of FIGS. 9 to 12, the transmitting terminal may transmit the DRX control signal, assume that the DRX operation is stopped after transmission of the DRX control signal, perform a resource sensing/selection operation, and transmit data to the receiving terminal using sensed resources (e.g., selected resources). The receiving terminal may receive the data from the transmitting terminal, and transmit a HARQ feedback for the data to the transmitting terminal.

The transmitting terminal may receive the HARQ feedback from the receiving terminal. When the HARQ feedback indicates ACK, the transmitting terminal may transmit new data to the receiving terminal. When the HARQ feedback indicates NACK, the transmitting terminal may retransmit the data to the receiving terminal. The transmitting terminal may not receive the HARQ feedback at a HARQ feedback reception time (e.g., PSFCH resource). In the instant case, the transmitting terminal may determine that the DRX operation is not stopped and may perform a retransmission operation of the DRX control signal. After retransmission of the DRX control signal, the transmitting terminal may perform subsequent operation(s) again. When there are sufficient resources for data transmission within the active time, the transmitting terminal may perform a data transmission operation on a PSCCH and/or PSSCH without transmitting a DRX control signal.

In the exemplary embodiment of FIG. 12, the receiving terminal may extend the active time after receiving the DRX control signal. In the instant case, the transmitting terminal may transmit data to the receiving terminal using resources sensed (e.g., resources selected) within the extended active time. Alternatively, the receiving terminal may change a long DRX cycle to a short DRX cycle after receiving the DRX control signal. In the instant case, the transmitting terminal may transmit the data to the receiving terminal using resources sensed (e.g., resources selected) within the active time according to the short DRX cycle.

To support the above-described operation, the DRX control signal may include information indicating to extend the active time and/or information indicating to change the DRX cycle. Alternatively, extension of the active time and/or change of the DRX cycle may be indicated to the terminal(s) by at least one of system information, RRC message, MAC message, or PHY message. The DRX operation may be maintained or stopped depending on whether the HARQ feedback is transmitted and received. Alternatively, the DRX operation may be maintained or stopped depending on whether the HARQ feedback indicates ACK or NACK.

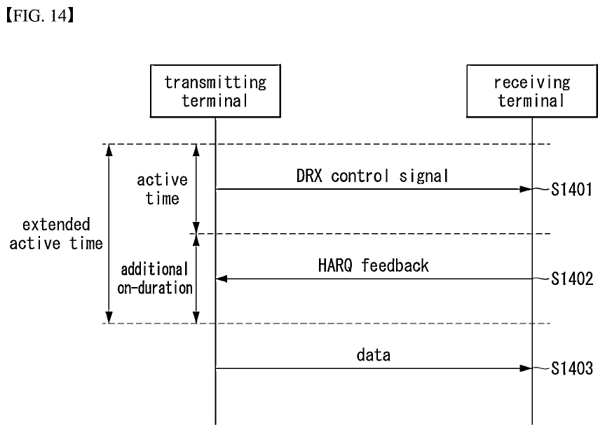

FIG. 13 is a sequence chart illustrating a fifth exemplary embodiment of DRX-based sidelink communication, and FIG. 14 is a sequence chart illustrating a sixth exemplary embodiment of DRX-based sidelink communication.

As shown in FIGS. 13 and 14, a transmitting terminal may transmit a DRX control signal to a receiving terminal (S1301, S1401). The receiving terminal may receive the DRX control signal from the transmitting terminal, and transmit a HARQ feedback for the DRX control signal to the transmitting terminal (S1302, S1402). The transmitting terminal may receive the HARQ feedback from the receiving terminal. After receiving the HARQ feedback, the transmitting terminal may transmit data to the receiving terminal (S1303, S1403). The receiving terminal may receive the data from the transmitting terminal. In the exemplary embodiment of FIG. 13, the transmission and reception operations of the HARQ feedback and data may be performed in an inactive time. In the exemplary embodiment of FIG. 14, the transmission and reception operations of the HARQ feedback may be performed in an extended active time, and the transmission and reception operation of the data may be performed in an inactive time. Alternatively, in the exemplary embodiment of FIG. 14, the transmission and reception operations of the HARQ feedback and data may be performed in an extended active time.

Information on PSFCH resources for HARQ feedback transmission may be included in at least one of first-stage SCI, second-stage SCI, data (e.g., data excluding second-stage SCI from a PSCCH), or MAC CE. A plurality of PSFCH resources may exist within a resource pool. The receiving terminal may select specific PSFCH resource(s) from the plurality of PSFCH resources in consideration of an ID of the transmitting terminal, ID of the receiving terminal, and/or parameter according to a cast scheme, and transmit the HARQ feedback in the selected specific PSFCH resource(s). The receiving terminal may select the earliest PSFCH resource in the time domain among the plurality of PSFCH resources within the resource pool, and may transmit the HARQ feedback to the transmitting terminal using the selected PSFCH resource.

The exemplary embodiments of FIGS. 9 to 12, extensions of the exemplary embodiments, or modifications of the exemplary embodiments may be applied to the exemplary embodiments of FIGS. 13 and/or 14. In the exemplary embodiments of FIGS. 11 and 12, the data may be transmitted after transmission of the DRX control signal. In the exemplary embodiments of FIGS. 13 and 14, the data may be transmitted after receiving the HARQ feedback for the DRX control signal. The operations based on the HARQ feedback in the exemplary embodiments of FIGS. 11 and 12, modifications of the operations, or extensions of the operations may be applied to the exemplary embodiments of FIGS. 13 and 14.

In the exemplary embodiments of FIGS. 13 and 14, whether to stop the DRX operation may be determined based on whether the HARQ feedback for the DRX control signal is received. Alternatively, whether to stop the DRX operation may be determined based on receipt of ACK or NACK for the DRX control signal. When the HARQ feedback for the DRX control signal is not received or when NACK for the DRX control signal is received, the transmitting terminal may retransmit the DRX control signal by using resources sensed (e.g., resources selected) within an active time of the receiving terminal. When there are sufficient resources sensed within the active time, the transmitting terminal may transmit data without retransmitting the DRX control signal.

In the exemplary embodiment of FIG. 13, the receiving terminal may operate in the wake-up state until a HARQ feedback transmission time. Alternatively, the receiving terminal may wake up at the HARQ feedback transmission time. The receiving terminal operating in the wake-up state may transmit the HARQ feedback to the transmitting terminal. In the exemplary embodiment of FIG. 14, the receiving terminal may transmit the HARQ feedback within the extended active time.

When ACK for the DRX control signal is received, the transmitting terminal may determine that the DRX operation of the receiving terminal is stopped and perform transmission and reception operations of data. When the DRX control signal includes resource information for transmission of data, the transmitting terminal may transmit the data to the receiving terminal in a resource indicated by the resource information, and the receiving terminal may receive the data in the resource indicated by the resource information.

When ACK for the DRX control signal occurs, the DRX operation may not be stopped. In this situation, even when the resource indicated by the DRX control signal belongs to an inactive time of the receiving terminal, the receiving terminal may operate in the wake-up state in the inactive time to receive the data. Alternatively, even when a period from the reception time of the DRX control signal to a reception time of the data belongs to an inactive time of the receiving terminal, the receiving terminal may operate in the wake-up state in the period and perform a reception operation for the data.

When ACK for the DRX control signal occurs, the DRX operation may not be stopped. In the exemplary embodiment of FIG. 14, the extended active time may be additionally extended so that transmission and reception operations for the HARQ feedback for the DRX control signal, data, and a HARQ feedback for the data are performed within the active time (e.g., extended active time). The active time may be extended as in the exemplary embodiment of FIG. 12.

In the exemplary embodiments of FIGS. 13 and 14, the DRX operation may be maintained or stopped depending on whether the HARQ feedback for the data is transmitted and received. Alternatively, the DRX operation may be maintained or stopped depending on whether the HARQ feedback for the data indicates ACK or NACK. The transmitting terminal may transmit a DRX control signal and/or data including a DRX operation indicator to the receiving terminal. The DRX operation indicator may indicate whether to perform the DRX operation. The receiving terminal may receive the DRX operation indicator from the transmitting terminal and determine whether to perform the DRX operation based on the DRX operation indicator. The DRX operation indicator may be included in at least one of first-stage SCI, second-stage SCI, data (e.g., data excluding second-stage SCI from a PSCCH), or MAC CE. The DRX operation indicator may be included in the DRX control signal described above.

In the exemplary embodiments of FIGS. 13 and 14, the transmitting terminal may not receive the HARQ feedback for the DRX control signal. In the instant case, the transmitting terminal may perform a resource sensing/selection operation in an active time of the receiving terminal, and may perform a retransmission operation for the data and/or DRX control signal in sensed resources (e.g., selected resources).

When data can be transmitted in resources (e.g., selected resource) sensed in the active time of the receiving terminal, the transmitting terminal may retransmit the data. When the resources sensed (e.g., selected resources) in the active time of the receiving terminal are not sufficient for data transmission, the transmitting terminal may retransmit the DRX control signal instead of the data.

The DRX control signal may include information indicating that the signal is a DRX control signal. The information (e.g., indication information of the DRX control signal) may be included in at least one of first-stage SCI, second-stage SCI, data (e.g., data excluding second-stage SCI from a PSCCH), or MAC CE.

In the exemplary embodiments of FIGS. 13 and 14, whether to stop the DRX operation may be determined based on whether the HARQ feedback for the DRX control signal is received. Alternatively, whether to stop the DRX operation may be determined based on occurrence of ACK or NACK for the DRX control signal. When ACK or NACK occurs for the DRX control signal, the DRX operation of the receiving terminal may be stopped. In the instant case, transmission and reception operations of data may be performed between the transmitting terminal and the receiving terminal. When ACK for the DRX control signal is received, the transmitting terminal may transmit new data to the receiving terminal. When NACK for the DRX control signal is received, the transmitting terminal may retransmit the data to the receiving terminal. When the HARQ feedback for the DRX control signal is not transmitted and received, the DRX operation may be continuously performed. When ACK or NACK occurs for the DRX control signal, the DRX operation of the receiving terminal may be stopped, and transmission and reception operations of data between the transmitting terminal and the receiving terminal may be performed.

In exemplary embodiments, when the DRX control signal is transmitted on a PSCCH, the transmitting terminal may transmit a DRX control signal including information indicating that only PSCCH transmission is performed without a PSSCH (e.g., information indicating a standalone PSCCH). The exemplary embodiments, modifications of the exemplary embodiments, and/or extensions of the exemplary embodiments may be applied to DRX operations in the RRC idle state, RRC inactive state, and/or RRC connected state. In the exemplary embodiments, signaling may be performed within an exceptional resource pool. Information on the exceptional resource pool may be transmitted using at least one of system information, RRC message, MAC message, or PHY message.

The transmitting terminal may perform a resource sensing/selection operation in an active time of the receiving terminal. When the receiving terminal performs a data transmission/reception operation with other terminal(s) or when the receiving terminal performs a DRX operation, the transmitting terminal may perform a resource sensing/selection operation based on information on an active time and/or RRC connection state of the receiving terminal. That is, the transmitting terminal may perform a resource sensing/selection operation in a period including a period in which the receiving terminal performs a PSCCH reception operation. The corresponding period may include an inactive time of the receiving terminal. The MAC layer of the transmitting terminal may transmit information on the period in which the receiving terminal performs the PSCCH reception operation as information on the active time to the PHY layer of the transmitting terminal. The PHY layer of the transmitting terminal may report a result of the resource sensing/selection operation to the MAC layer of the transmitting terminal.

Methods according to the present disclosure may be implemented in form of program instructions executable through various computer means, and may be recorded on a computer-readable medium. The computer-readable medium may include the program instructions, data files, data structures, etc., singly or in combination. The program instructions recorded on the computer-readable medium may be specially designed and constructed for the present disclosure or may be known and usable by those skilled in the computer software art.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-stage language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), the method comprising:
generating a discontinuous reception (DRX) control signal for controlling a DRX operation; and
transmitting the DRX control signal to a second UE in an active time of the second UE according to the DRX operation.

2. The method of claim 1, wherein the DRX control signal includes at least one of information indicating to stop the DRX operation, information indicating to transition an operating state of the second UE, information indicating to change a DRX cycle according to the DRX operation, or information indicating to extend the active time.

3. The method of claim 2, wherein in response to the information indicating to stop the DRX operation, the DRX operation is not performed in the second UE, and in response to the information indicating to transition an operating state of the second UE, the operating state of the second UE transitions to a wake-up state.

4. The method of claim 2, wherein win response to the information indicating to change a DRX cycle according to the DRX operation, the DRX cycle of the second UE is changed from a first DRX cycle to a second DRX cycle, and a length of the first DRX cycle and a length of the second DRX cycle are different from each other.

5. The method of claim 2, further comprising: in response to the information indicating to extend the active time, performing sidelink (SL) communication with the second UE in an extended active time of the second UE.

6. The method of claim 5, wherein the performing of the SL communication comprises:
transmitting data to the second UE; and
receiving, from the second UE, a hybrid automatic repeat request (HARQ) feedback for the data.

7. The method of claim 5, wherein the performing of the SL communication comprises:
receiving, from the second UE, a HARQ response to the DRX control signal; and
transmitting data to the second UE.

8. The method of claim 5, wherein the performing of the SL communication comprises:
performing a resource sensing operation in a first resource sensing window within the extended active time;
performing a resource selection operation for sensed resources in a first resource selection window within the extended active time; and
transmitting data to the second UE using selected resources,
wherein the first resource sensing window is larger than a second resource sensing window within the active time, and the first resource selection window is larger than a second resource selection window within the active time.

9. The method of claim 5, wherein the extended active time includes the active time and an additional on-duration, and the additional-on duration is configured by the base station.

10. The method of claim 5, wherein the DRX control signal is transmitted in the active time of a DRX cycle #n, and the extended active time is configured in a DRX cycle #n+k, and n and k are each natural numbers.

11. A method of a second user equipment (UE), the method comprising:
performing a monitoring operation in an active time according to a discontinuous reception (DRX) operation;
receiving a DRX control signal for controlling the DRX operation from a first UE by the monitoring operation; and
performing sidelink (SL) communication with the first UE based on the DRX control signal.

12. The method of claim 11, wherein the DRX control signal includes at least one of information indicating to stop the DRX operation, information indicating to transition an operating state of the second UE, information indicating to change a DRX cycle according to the DRX operation, or information indicating to extend the active time.

13. The method of claim 12, wherein in response to the information indicating to stop the DRX operation, the SL communication is performed without the DRX operation, and in response to the information indicating to transition an operating state of the second UE, the operating state of the second UE transitions to a wake-up state.

14. The method of claim 12, wherein in response to the information indicating to change a DRX cycle according to the DRX operation, the DRX cycle of the second UE is changed from a first DRX cycle to a second DRX cycle, and a length of the first DRX cycle and a length of the second DRX cycle are different from each other.

15. The method of claim 12, wherein in response to the information indicating to extend the active time, the SL communication is performed in an extended active time of the second UE.

16. The method of claim 15, wherein the performing of the SL communication comprises:
receiving data from the first UE; and
transmitting a hybrid automatic repeat request (HARQ) feedback for the data to the first UE.

17. The method of claim 15, wherein the performing of the SL communication comprises:
transmitting a HARQ response to the DRX control signal to the first UE; and
receiving data from the first UE.

18. The method of claim 15, wherein the extended active time includes the active time and an additional on-duration, and the additional-on duration is configured by the base station.

19. The method of claim 15, wherein the DRX control signal is received in the active time of a DRX cycle #n, and the extended active time is configured in a DRX cycle #n+k, and n and k are each natural numbers.
